(19) United States
(12) Patent Application Publication
(10) Pub. No.: US 2013/0318605 A1
(43) Pub. Date: Nov. 28, 2013

(54) SYSTEM FOR DETECTING ROGUE NETWORK PROTOCOL SERVICE PROVIDERS

(71) Applicant: Jeffery L. Crume, Raleigh, NC (US)

(72) Inventor: Jeffery L. Crume, Raleigh, NC (US)

(73) Assignee: INTERNATIONAL BUSINESS MACHINES CORPORATION, Armonk, NY (US)

(21) Appl. No.: 13/479,418

(22) Filed: May 24, 2012

(51) Int. Cl. G06F 21/00; G06F 15/173

(52) U.S. Cl. 726/23; 709/224

(57) ABSTRACT

A method, system, and computer program product embodied in a computer readable storage medium are disclosed for identifying a rogue network protocol service provider. Embodiments include passively monitoring traffic on a target network, and identifying a response to a network protocol request in the traffic on the network. The source of the response to a network protocol request is compared with a preconfigured list of authorized servers. Based on the results of the comparison, it can be determined whether the source of the response is an authorized server. In cases in which the source is a server on the preconfigured list of authorized servers, the source is deemed an authorized server. In cases in which the source is not a server on the preconfigured list of authorized servers, the source is deemed to be an unauthorized, or rogue, network protocol service provider.

### CROSS REFERENCE TO RELATED APPLICATION

This patent application is related to commonly-assigned U.S. patent application Ser. No. ______ (Attorney Docket No. CHA920120009US1), filed concurrently with this application.

### TECHNICAL FIELD

The invention relates generally to identifying untrusted or compromised sources of network information. More particularly, the invention relates to identifying a rogue network protocol service provider in a network.

### BACKGROUND

Network protocols such as DHCP (Dynamic Host Configuration Protocol) for internet protocol (IP) address assignment, DNS (Domain Name Service) for IP address resolution, and BGP (Border Gateway Protocol) for IP routing depend upon the trustworthiness of a server or network of servers to supply accurate information to requesters. For instance, if a workstation connects to a network it may request an IP address from a DHCP server, an IP address resolution for a target domain name from a DNS server, and/or routing information on how to reach that target domain from a BGP (or other routing protocol) server. If, however, the information supplied through these services comes not from an authorized source, but rather, an attacker's system supplying incorrect information, network traffic could be impeded in a denial of service (DOS) attack or misrouted in a spoofing attack resulting in sensitive traffic being delivered to untrusted systems.

One way that these services could be subverted would be for an attacker to set up an “evil twin” WiFi hotspot that impersonates a trusted wireless access point and establishes itself as a man-in-the-middle (MITM) which can examine and modify all traffic coming into and going out of the rogue network. Another way would be for the attacker to set up a rogue server that hijacks network services by broadcasting to all nodes in the network that it is online and available to process requests. In many cases, the last server to broadcast will be considered authoritative by other nodes in the network.

Typically, network intrusion prevention systems (NIPS) and network intrusion detection systems (NIDS) look for particular patterns of anomalous behavior, such as malformed packets or suspicious sequences of traffic in a general sense. NIPS and NIDS typically do not verify whether networking services are being provided by an authorized host. Accordingly, they may detect an attacker breaking into a DNS server and compromising it, for example, but they would not detect occurrences in which DNS resolutions, DHCP addresses, etc. are being provided by a rogue source.

### BRIEF DESCRIPTION

In general, aspects of the present invention provide a passive monitoring solution for identifying a rogue network protocol service provider which does not generate additional network traffic, and is able to detect occurrences in which network protocol information such as, for example, DHCP addresses, DNS resolutions, and other network protocol information are being provided by rogue untrusted sources.

A first aspect of the disclosure provides a method for identifying a rogue network protocol service provider. The method comprises passively monitoring traffic on a network; and identifying a response to a network protocol request in the traffic on the network. The source of the response is compared to a preconfigured list of authorized servers. It can then be determined whether the source of the response is an authorized server. In a case in which the source is a server on the preconfigured list of authorized servers, the source is an authorized server. In a case in which the source is not a server on the preconfigured list of authorized servers, the source is not an authorized server.

A second aspect of the disclosure provides a system for identifying a rogue network protocol service provider. The system comprises a monitoring component for passively monitoring traffic on a network; and an identification component for identifying a response to a network protocol request in the traffic on the network. A comparison component is used to compare a source of the response to a preconfigured list of authorized servers. In a case in which the source is a server on the preconfigured list of authorized servers, the source is an authorized server. In a case in which the source is not a server on the preconfigured list of authorized servers, the source is not an authorized server.

A third aspect of the disclosure provides a computer program product embodied in a computer readable storage medium which, when executed by a computing device, causes the computer system to implement a method for identifying a rogue network protocol service provider. The method comprises passively monitoring traffic on a network; and identifying a response to a network protocol request in the traffic on the network. The source of the response is compared to a preconfigured list of authorized servers. It can then be determined whether the source of the response is an authorized server. In a case in which the source is a server on the preconfigured list of authorized servers, the source is an authorized server. In a case in which the source is not a server on the preconfigured list of authorized servers, the source is not an authorized server.

These and other aspects, advantages and salient features of the invention will become apparent from the following detailed description, which, when taken in conjunction with the annexed drawings, where like parts are designated by like reference characters throughout the drawings, disclose embodiments of the invention.

### BRIEF DESCRIPTION OF THE DRAWINGS

FIG. 1 shows a data processing system suitable for implementing an embodiment of the invention.

FIG. 2 shows a schematic data flow diagram illustrating a process for monitoring of a network according to an embodiment of the invention.

FIG. 3 shows a schematic data flow diagram illustrating a process for identifying a rogue network protocol server according to an embodiment of the invention.

FIG. 4 shows a flow chart depicting a method of identifying a rogue DNS server in accordance with an embodiment of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, aspects of the present invention provide a solution for detecting the presence of rogue network protocol service providers through the use of a monitor which passively observes the flow of traffic across a network between nodes, and looks for networking service traffic originating from untrusted sources in that network. In some embodiments, the network may be a local Intranet, and in others, the network may be the Internet.

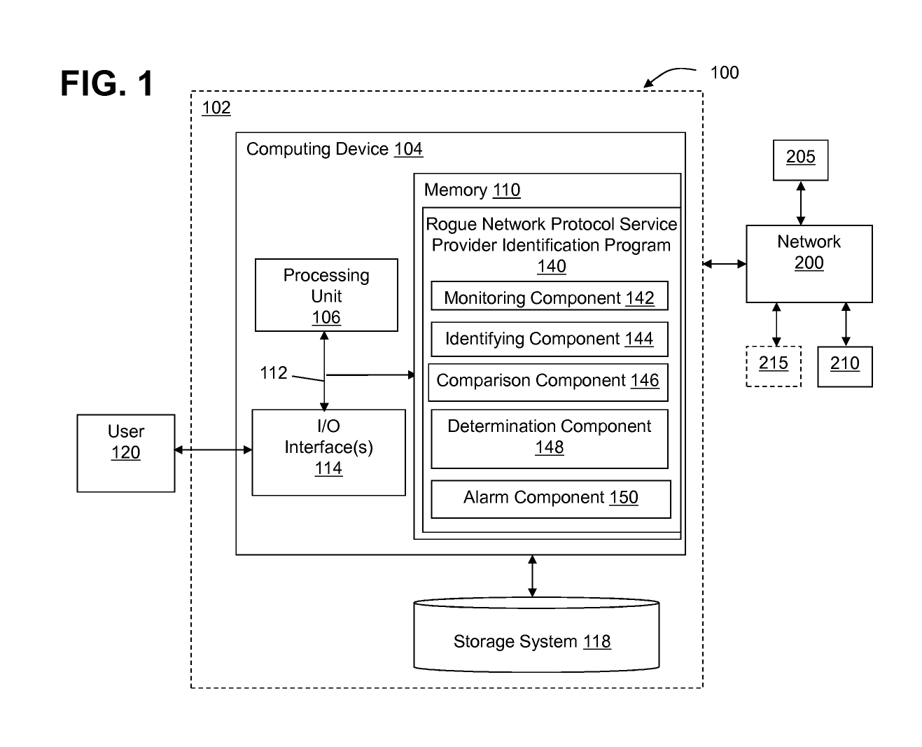

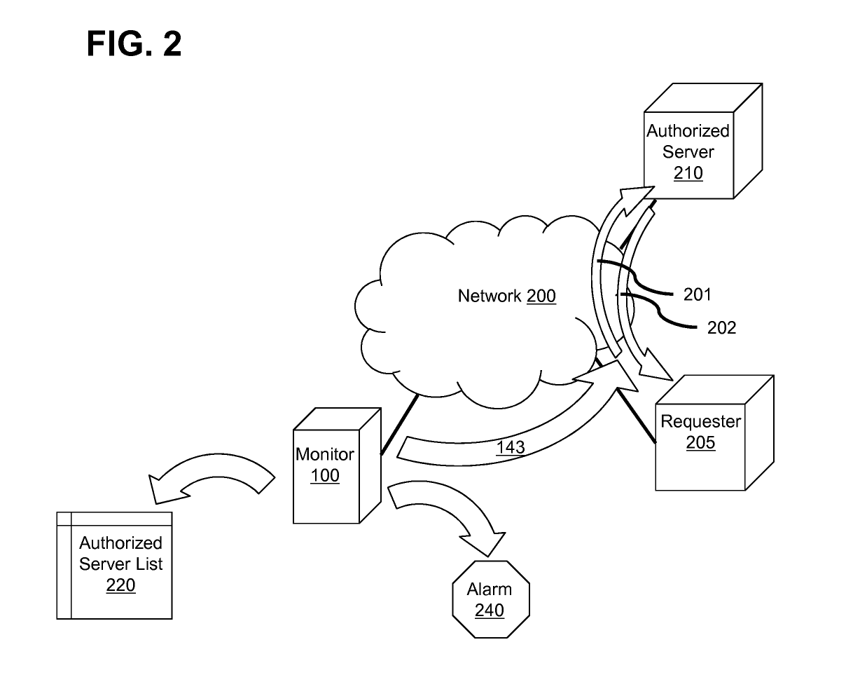

Turning to the drawings, FIG. 1 shows an illustrative monitor 100 for detecting the presence of rogue network protocol service providers 215 (FIG. 2) that may be present in network 200. To this extent, monitor 100 includes a computer system 102 that can perform a process described herein in order to identify a response to a network protocol request from a rogue network protocol service provider 215. In particular, computer system 102 is shown including a computing device 104 that includes a rogue network protocol service provider identification program 140, which makes computing device 104 operable to identify a rogue network protocol service provider 215 by performing a process described herein.

Computing device 104 is shown including a processing unit 106 (e.g., one or more processors), a memory 110, a storage system 118 (e.g., a storage hierarchy), an input/output (I/O) interface component 114 (e.g., one or more I/O interfaces and/or devices), and a communications pathway 112. In general, processing unit 106 executes program code, such as rogue network protocol service provider identification program 140, which is at least partially fixed in memory 110. To this extent, processing unit 106 may comprise a single processing unit, or be distributed across one or more processing units in one or more locations.

Memory 110 can also include local memory, employed during actual execution of the program code, bulk storage (storage 118), and/or cache memories (not shown), which provide temporary storage of at least some program code in order to reduce the number of times code must be retrieved from bulk storage 118 during execution. As such, memory 110 may comprise any known type of data storage and/or transmission media, including magnetic media, optical media, random access memory (RAM), read-only memory (ROM), a data cache, a data object, etc. Moreover, similar to processing unit 116, memory 110 may reside at a single physical location, comprising one or more types of data storage, or be distributed across a plurality of physical systems in various forms.

While executing program code, processing component 106 can process data, which can result in reading and/or writing transformed data from/to memory 110 and/or I/O component 114 for further processing. Pathway 112 provides a direct or indirect communications link between each of the components in computer system 102. I/O interface component 114 can comprise one or more human I/O devices, which enable a human user 120 to interact with computer system 102 and/or one or more communications devices to enable a system user 120 to communicate with computer system 102 using any type of communications link.

To this extent, rogue network protocol service provider identification program 140 can manage a set of interfaces (e.g., graphical user interface(s), application program interface, and/or the like) that enable human and/or system users 120 to interact with rogue network protocol service provider identification program 140. Further, rogue network protocol service provider identification program 140 can manage (e.g., store, retrieve, create, manipulate, organize, present, etc.) the data, such as data stored in authorized network protocol service provider list 220, using any solution.

In any event, computer system 102 can comprise one or more general purpose computing articles of manufacture 104 (e.g., computing devices) capable of executing program code, such as rogue network protocol service provider identification program 140, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, rogue network protocol service provider identification program 140 can be embodied as any combination of system software and/or application software. In any event, the technical effect of computer system 102 is to provide processing instructions to computing device 104 in order to identify a rogue network protocol service provider.

Further, rogue network protocol service provider identification program 140 can be implemented using a set of modules 142-150. In this case, a module 142-150 can enable computer system 102 to perform a set of tasks used by rogue network protocol service provider identification program 140, and can be separately developed and/or implemented apart from other portions of rogue network protocol service provider identification program 140. As used herein, the term “component” means any configuration of hardware, with or without software, which implements the functionality described in conjunction therewith using any solution, while the term “module” means program code that enables a computer system 102 to implement the actions described in conjunction therewith using any solution. When fixed in a memory 110 of a computer system 102 that includes a processing component 106, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 102.

When computer system 102 comprises multiple computing devices 104, each computing device 104 can have only a portion of rogue network protocol service provider identification program 140 fixed thereon (e.g., one or more modules 142-150). However, it is understood that computer system 102 and rogue network protocol service provider identification program 140 are only representative of various possible equivalent computer systems that may perform a process described herein. To this extent, in other embodiments, the functionality provided by computer system 102 and rogue network protocol service provider identification program 140 can be at least partially implemented by one or more computing devices that include any combination of general and/or specific purpose hardware with or without program code. In each embodiment, the hardware and program code, if included, can be created using standard engineering and programming techniques, respectively.

When computer system 102 includes multiple computing devices 104, the computing devices can communicate over any type of communications link. Further, while performing a process described herein, computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, rogue network protocol service provider identification program 140 enables computer system 102 to implement identification of a rogue network protocol service provider. To this extent, rogue network protocol service provider identification program 140 is shown including a monitoring module 142, an identifying module 144, a comparison module 146, a determination module 148, and an alarm module 150.

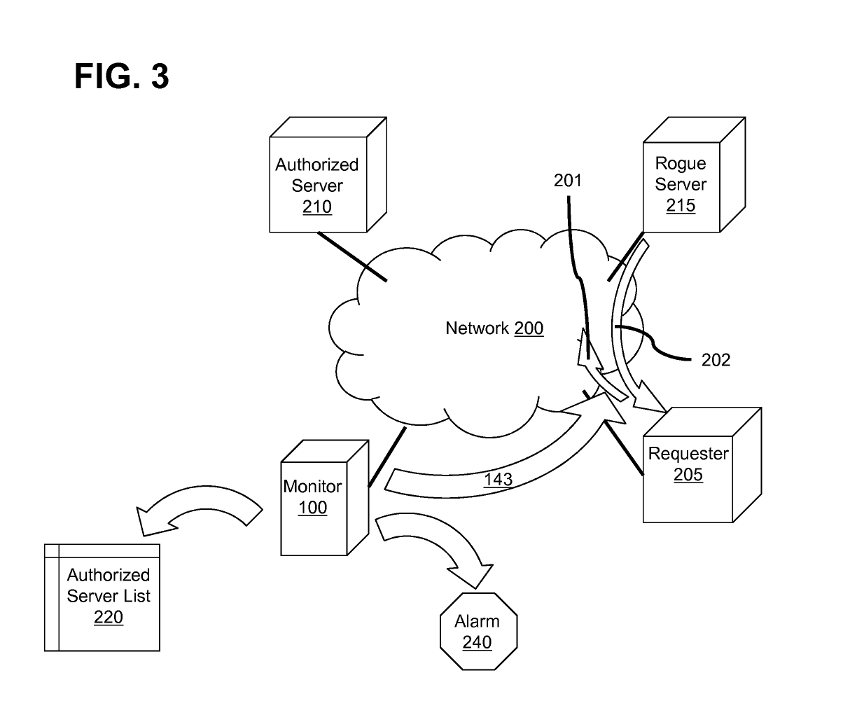

Referring now to FIGS. 2-3, the data flow through network 200 will now be described. As illustrated, network 200 may include a requester 205, which may be a client workstation operated by a user or a server. Additional requesters 205 may be included in network 200, but are omitted from the depiction of network 200 in FIGS. 2-3 for simplicity. Requester 205 may send a network protocol request 201 for any of a number of different types of network service information. For example, in various embodiments, request 201 may be requesting DNS resolution of a particular host's alphanumeric domain name into a numeric IP address; DHCP assignment of an IP address; or BGP assignment of IP routing. Request 201 may also comprise any other network protocol request for which service hijacking and spoofing are possible.

As shown in FIG. 2, under normal or secure operating conditions, in which an attacker is not present in network 200, network protocol request 201 is received and processed by authorized network protocol server 210, which sends response 202 to requester 205 via network 200.

In other cases, as shown in FIG. 3, an attacker's rogue network protocol server 215 may be present in network 200 with the purpose of impersonating another computing system. In this case, network protocol request 201 is received and processed by rogue network protocol server 215, and response 202 is provided by rogue network protocol server 215. Such a response 202 may come from an untrusted source, and may contain incorrect network protocol information, resulting in a variety of problematic situations. For example, if incorrect, duplicative, or successive IP addresses are assigned to a requester 205, requester 205 may not be able to access the network, may lose access when his/her IP address is subsequently given to another requester, or rogue network protocol server 215 may burn up available IP addresses. This is only one example. If, for instance, incorrect DNS resolutions are provided, sensitive traffic from requester 205 may be misrouted to an untrusted system. Other similarly undesirable consequences will also be apparent to those practiced in the art.

In either case, monitor 100 is positioned at a strategic point in network 200 such that monitor 100 can observe the flow of network traffic between nodes on network 200. As discussed above with reference to FIG. 1, monitor 100 includes modules 142-150, which when executed by computer system 102, perform passive monitoring of traffic on network 200, including, among other network traffic, network protocol requests 201 and responses 202.

Referring concurrently to FIGS. 1-3, monitoring module 142, part of monitor 100, performs monitoring 143 of traffic across network 200, including network protocol requests 201 and responses 202. Identification component 144 can identify, in the traffic monitored on the network 200, a network protocol response 202. As mentioned previously, a network protocol response 202 may contain any of a number of types of network protocol information in response to a network protocol request 201 sent by requester 205.

Once a network protocol response 202 is identified, comparison module 146 can perform a comparison of the response 202 with a preconfigured list 220 of authorized servers. The authorized servers included in preconfigured list 220 may be identified by IP address or by MAC address in various embodiments. The authorized servers listed in the preconfigured list 220 are known to be trusted sources of network protocol information.

According to embodiments of the invention, the preconfigured list 220 of authorized servers may be an exhaustive list of authorized servers that a user of network 200 may access, or from which requester 205 may request network protocol information, although this is not strictly required. In other embodiments, preconfigured list 220 may include a non-exhaustive list of authorized servers that a user of network 200 may access. However, since the list of authorized DNS, DHCP, BGP, etc. servers is typically of manageable volume and does not typically change frequently, a white list approach to identifying trusted sources may be used effectively, and is in fact advantageous because it does not require the identification of untrusted sources.

Referring back to FIGS. 1-3, determination module 148 (FIG. 1) performs a determination of whether the source of network protocol response 202 is an authorized server. This determination is based on the comparison performed by comparison module 146. Where the source matches a server on the preconfigured list 220 of authorized servers, the source is deemed an authorized server 210, as shown in FIG. 2. Where the source does not match a server on the preconfigured list 220 of authorized servers, the source is deemed to be an unauthorized, or rogue server 215. In this case, alarm module 150 sends an alarm 240 to advise requester 205 of the unauthorized source of response 202, and the appurtenant potential security risk. In various embodiments, alarm 240 may take the form of a message, such as by email, SMS, etc., a log entry, or other form of security event notification which documents and draws attention to the suspicious behavior.

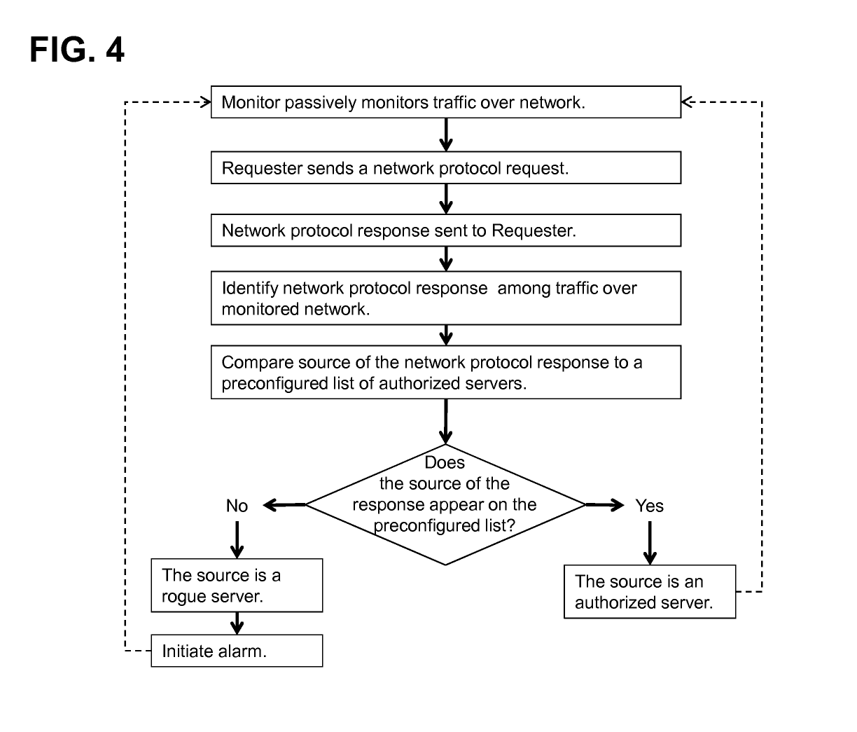

The foregoing method can also be described with respect to the flow chart in FIG. 4. As previously described, a monitor passively monitors traffic over a network. Over this network, a requesting workstation sends a network protocol request. A network protocol response is returned to the requester by a server via the network. The network protocol response is identified by the monitor among the monitored network traffic. Once identified, the source of the response is compared to a preconfigured list of authorized servers, and it is determined whether the source of the response is an authorized server, or a trusted source of network protocol information. If the source is a server on the preconfigured list of authorized servers, then the source is an authorized server. If the source is a server that is not on the preconfigured list of authorized servers, then the source is an unauthorized, or rogue server. In this instance, an alarm is initiated, alerting the requester to the security risk.

While shown and described herein as a method and system for identifying a rogue network protocol service provider, it is understood that aspects of the invention further provide various alternative embodiments. For example, in one embodiment, the invention provides a computer program fixed in at least one computer-readable medium, which when executed, enables a computer system to implement identification of a rogue network protocol service provider. To this extent, the computer-readable medium includes program code, such as rogue network protocol service provider identification program 140 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as rogue network protocol service provider identification program 140 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for identifying a rogue network protocol service provider. In this case, a computer system, such as computer system 102 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

As used herein, the terms “first,” “second,” and the like, do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the server(s) includes one or more server). Ranges disclosed herein are inclusive and independently combinable (e.g., ranges of “up to about 3 servers, or, more specifically, about 1 server to about 3 servers,” is inclusive of the endpoints and all intermediate values of the ranges of “about 1 server to about 2 servers,” etc.).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for identifying a rogue network protocol service provider, the method comprising:
on a computing device, passively monitoring traffic on a network;
on a computing device, identifying a response to a network protocol request in the traffic on the network;
on a computing device, comparing a source of the response to a preconfigured list of authorized servers;
on a computing device, determining whether the source of the response is an authorized server on the preconfigured list of authorized servers,
wherein in a case in which the source is a server on the preconfigured list of authorized servers, the source is an authorized server, and
wherein in a case in which the source is not a server on the preconfigured list of authorized servers, the source is not an authorized server, and
on a computing device, sending a SMS message, a log entry, or a security event notification in response to determining that the source is not an authorized server.

2-3. (canceled)

4. The method of claim 1, wherein the response to the network protocol request includes an IP address assignment for use by a requester.

5. The method of claim 1, wherein the response to the network protocol request includes a resolution of a domain name to an internet protocol (IP) address.

6. The method of claim 1, wherein the response to the network protocol request includes an internet protocol (IP) routing.

7. The method of claim 1, wherein the case in which the source is not an authorized server indicates at least one of: a spoof attack, a service hijacking, or a denial of service (DOS) attack.

8. The method of claim 1, wherein the network includes an intranet.

9. A system for identifying a rogue network protocol service provider, the system comprising:
a monitoring component for passively monitoring traffic on a network;
an identification component for identifying a response to a network protocol request in the traffic on the network;
a comparison component for comparing a source of the response to a preconfigured list of authorized servers,
wherein in a case in which the source is a server on the preconfigured list of authorized servers, the source is an authorized server, and
wherein in a case in which the source is not a server on the preconfigured list of authorized servers, the source is not an authorized server; and
an alarm component for sending message, a log entry, or a security event notification in response to determining that the source is not an authorized server.

10. (canceled)

11. The system of claim 9, wherein the response to the network protocol request includes an IP address assignment for use by a requester.

12. The system of claim 9, wherein the response to the network protocol request includes a resolution of a domain name to an internet protocol (IP) address.

13. The system of claim 9, wherein the response to the network protocol request includes an internet protocol (IP) routing.

14. The system of claim 9, wherein the case in which the source is not an authorized server indicates at least one of: a spoof attack, a service hijacking, or a denial of service (DOS) attack.

15. A computer program product embodied in a non-transitory computer readable storage medium which, when executed by a computing device, causes the computer system to implement a method for identifying a rogue network protocol service provider, the method comprising:
passively monitoring traffic on a network;
identifying a response to a network protocol request in the traffic on the network;
comparing a source of the response to a preconfigured list of authorized servers;
determining whether the source of the response is an authorized server,
wherein in a case in which the source is a server on the preconfigured list of authorized servers, the source is an authorized server, and
wherein in a case in which the source is not a server on the preconfigured list of authorized servers, the source is not an authorized server; and
sending a SMS message, a log entry, or a security event notification in the case in which the source is not a server on the preconfigured list of authorized servers the source is not an authorized server.

16. (canceled)

17. The computer program product of claim 15, wherein the response to the network protocol request includes an IP address assignment for use by a requester.

18. The computer program product of claim 15, wherein the response to the network protocol request includes a resolution of a domain name to an internet protocol (IP) address.

19. The computer program product of claim 15, wherein the response to the network protocol request includes an internet protocol (IP) routing.

20. The computer program product of claim 15, wherein the network includes an intranet.
